(19) United States
(12) Patent Application Publication
(10) Pub. No.: US 2009/0108031 A1
(43) Pub. Date: Apr. 30, 2009

(54) Beverage-Flow Restricting Conduit and Methods for Manufacturing and Assembling Same

(76) Inventor: Ian Anderson, Burwell Cambridge (GB)

Correspondence Address: Levy & Grandinetti, P.O. Box 18385, Washington, DC, 20036, US

(21) Appl. No.: 11/883,570

(22) PCT Filed: Jan. 26, 2006
(86) PCT No.: PCT/IB2006/000137

§ 371 Date: Dec. 3, 2007

(30) Foreign Application Priority Data
Feb. 4, 2005 (GB) 0502382.5

(51) Int. Cl. B65D 83/00; F16L 55/00; B67D 3/00

(52) U.S. Cl. 222/394; 138/26; 222/564

(57) ABSTRACT

A conduit (200) is adapted to pass a fluid there-through and provides a flow restriction (201) across an operational pressure drop between a liquid inlet into and outlet from that restriction. The conduit comprises a cooperative plurality of mutually inter-fitting longitudinal sections (202) of an elongated tubular body (203) enclosing a longitudinally-extending passage (204) for the fluid to pass between respective mutually opposed surfaces (204a, 204b) thereof. The surfaces are conformed so that with the sections arranged in conjoined relation and the portions engaged in cooperative inter-fitting register, the flow restriction is defined between the respective conformed surfaces.

### FIELD OF THE INVENTION

The present invention relates to the construction, assembly and use of flow restricting conduits, particularly in relation to gas in liquid solutions and especially in beverage dispense applications—including without limiting the generality of the foregoing, the dispense of beer in short-run dispense installations/appliances.

### BACKGROUND OF THE INVENTION

The production of flow-restricting conduits for conducting fluids there through, can be problematic. Ease/cost of manufacturing and the requisite shaping/precision for the flow restriction surfaces can be at odds with the demands of the application—especially in cases where disposable conduits are employed to conduct less than perfectly stable gas in liquid solutions.

Longitudinal machining, such as drilling, (from mutually-opposed directions down the longitudinal axis of the conduit), with shaped drills adapted to open up channels having a flow-restricting geometry therein, has proven to be difficult—resulting in limited quality control, and consequential destabilization (during the passage there-through) of gas in liquid solutions such as beer, during the dispensing thereof. The use of “pins” to configure these channels in lieu of drilling has also proved to be difficult because of bending and the requisite tolerances have not proven to be adequately controllable.

There is a need in the art to provide a flow restricting assembly, and more particularly, to provide an alternative to a current method for the construction/assembly thereof, but even more so, to deal with a multi-phase solution (especially gas in liquid solutions under relatively unstable conditions) and even more particularly and especially to address the particularly problematic issues surrounding the dispense of beer from a keg system, and finally, in “short-run” beer dispensing appliances.

### SUMMARY OF THE INVENTION

Broadly speaking, the present invention relates generally to a conduit, adapted to pass a fluid there-through and providing a flow restriction across an operational pressure drop between a fluid inlet into and an outlet from that restriction.

More particularly, the conduit comprises a cooperative plurality of mutually inter-fitting longitudinal sections of a longitudinally-elongated tubular body. Those sections are adapted to enclose a longitudinally-extending passage for the fluid, between respective mutually opposed surfaces of those sections.

These respective mutually opposed surfaces are conformed so that, (with the sections arranged in conjoined relation and the portions engaged in cooperative inter-fitting register), the flow restriction is defined between the respective conformed surfaces.

More particularly, the present invention relates to a conduit, adapted to pass a fluid, (and especially liquids), substantially as hereinbefore described, but wherein the conduit comprises clamping means adapted to clampingly engage the cooperative plurality of mutually inter-fitting longitudinal sections of the longitudinally-elongated tubular body that encloses the longitudinally-extending passage for that fluid. As before, the surfaces are so conformed that with the sections arranged in this clamped inter-relation with the portions engaged in cooperative inter-fitting register, the flow restriction is defined between the respective conformed surfaces.

In a preferred form of the present invention, the flow restriction is a flow restricting venturi-type constriction within the passage. In the case of the present invention “venturi type” flow constriction does not necessarily mean a tube in which pressure drop is used to measure fluid flow, as is sometimes more generally the application of a venturi in the art. For the present purposes however, a venturi is a tube with a tapering constriction in the middle that causes an increase in the velocity of flow of a fluid and a corresponding decrease in fluid pressure. Although this type of tube can useful in measuring fluid flow or for creating a suction (as for driving aircraft instruments or drawing fuel into the flow stream of a carburetor), the use of a venturi-type tube in the context of the present invention is focused on managing the pressure transition of a fluid across the above-mentioned tapering constriction. More precisely, the term as used herein refers to a tube which provides for convergent flow between tapering sidewalls on an upstream side, followed proximately (but not necessarily immediately), by divergently tapering sidewalls downstream thereof. Additionally, as in, for example, the instance of a beer dispense system (such as is described more elaborately elsewhere herein), the application of this venturi-type tube collaterally manages the delivered volumetric flow rate through the tube from a relatively high upstream supply pressure, to a relatively low pressure downstream of the tube.

In a particularly preferred form of the present invention, the above mentioned clamping means comprises a sleeve, with the body comprising an insert adapted to be received in clamped engagement within that sleeve. Preferably, the sleeve not only provides the clamping forces that secure the body, but also augment the “fluid sealing function” of the conduit that keeps the fluid contained therein.

In a particularly useful application of the present invention, a conduit, is adapted to pass a gas-in-liquid solution (such as a “carbonated” liquid, for example) there-through. In this application the conduit is adapted to provide a flow restricting venturi for mitigating, whether in whole or at least in part, against foam production during the transit of the carbonated liquid across an operational pressure drop between a liquid inlet into and an outlet from said venturi. This application of the invention is particularly concerned with liquids that hold gas in solution therein, in such proportions that the gas can be fairly readily released there from. Typical examples might be carbonated soft drinks, but in particular, many beers contain soluble gases such as carbon dioxide and/or nitrogen, and these two fall within the intended scope of this application of the present invention. In this application, it is particularly preferred that the conduit embodies the clamping sleeve adapted as aforesaid to receive the cooperative plurality of mutually inter-fitting longitudinal portions of an elongated tubular insert enclosing a longitudinally-extending passage for said liquid between respective mutually opposed surfaces thereof.

### PREFERRED EMBODIMENTS OF THE PRESENT INVENTION

A preferred embodiment of the present invention comprises a beverage dispense system that in combination, adapted to pass a beverage from a reservoir to a dispensing tap, across a pressure drop there between, and in particular through a conduit comprising conduit, adapted to pass a fluid there-through and providing a flow restriction across an operational pressure drop between a fluid inlet into and an outlet from that restriction. In general, in this embodiment, the conduit comprises the previously described cooperative plurality of mutually inter-fitting longitudinal sections of the longitudinally-elongated tubular body. Those sections are adapted to enclose a longitudinally-extending passage for the fluid, between respective mutually opposed surfaces of those sections, with the respective mutually opposed surfaces being so conformed that, (with the sections arranged in conjoined relation and the portions engaged in cooperative inter-fitting register), the flow restriction is defined between the respective conformed surfaces. A clamped arrangement is particularly preferred for this embodiment, and a sleeve arrangement is especially preferred for these purposes, again, substantially as described hereinabove.

### DETAILED DESCRIPTION OF PREFERRED EMBODIMENTS

Beer, (however it may have been packaged), typically contains greater or lesser amounts of dissolved gases (in most cases, carbon dioxide, but in some cases also nitrogen, or mixtures of nitrogen and carbon dioxide). The dissolved gas and the change in partial pressures that usually occur when the beer is poured from its primary packaging, results in the production of foam. In some measure, this can be a desirable outcome: the “foam head” of a beer is considered by many to be aesthetically pleasing part of the overall beer experience with considerable science and poetry having been devoted to its description and merits.

Ironically, what makes beer so special to its adherents, poses special problems, (or at least manifestly exacerbates these problems), in the management of its dispense. Soft drinks are not nearly so sensitive—with the constituency of beer being ever so much more inherently and significantly sensitive to foaming issues, in part because of the higher CO2 content and more particularly because of the protein and carbohydrate constituents.

In dispensing beer using any of the so-called draft (or draught, or keg beer) systems, the production of foam can be particularly problematic. The difficulty can arise for a number of reasons, but in particular, there is a need to manage the pressure during dispensing of the beer so that the amount of foam that is produced does not become excessive.

Managing the pressure in this sense comes down to managing transitions in the degree and rate of change of partial pressures of the dissolved and un-dissolved gas (or gases as the case may be), as the beer is dispensed from a higher packaged gauge pressure to a lower ambient gauge pressure. A so-called “balanced” dispense system is required to achieve these ends.

In a “balanced” beer dispense system, the beer can be served with close to the dissolved gas levels at which it was produced, with expected losses given over to the production of appropriate and expected amounts of foam in the beer's “head”. The kinesthetic and organoleptic properties of the beer are in this sense, not compromised by the dispensing operation. The balance of the dispense pressures that are needed for this purpose, is accommodated by using sufficient flow restriction in the dispense line such that the velocity at the faucet is reasonable while the loss of dissolved gas or gasses remains within the bounds of expectations. Line length, diameter, and flow restrictions such as in-line venturi-type flow constriction. For the purposes of the present invention, the overall design and operation of an appropriately balanced beer dispense system is, in general, well within the skill of persons skilled in the beer dispense art.

Accordingly, the present invention is particularly concerned with the application thereof in relation to the dispense of beer. In that connection and in a particularly preferred form of the invention, the conduit as variously described herein before, is an inexpensive, plastic disposable device—and is embodied as a cartridge that is adapted for use in a beer dispense appliance, including in particular such devices as are useful in home dispense applications.

Note that the importance, if not the criticality, of flow restriction design and performance is most acute in “short-run” applications, such as those that arise in such beer dispense appliances. Short-run in this sense refers to the physical distance over which the beer makes its way from the beer reservoir (typically a keg of some description or another), and the dispensing tap. The shorter the distance, the less the inherent moderation in changes in the pressure to which the beer is exposed, and hence the greater the need for pressure management by way of flow constrictions such as that of the present invention. A short run in this sense would be less than a meter or so, and typically half a meter or less, down to as short as a third of a meter or even slightly less—say in the range of as little as four to six inches in length.

### INTRODUCTION TO THE DRAWINGS

In the following detailed description of various aspects of the present invention, reference will be made to the appended drawings, in which:

FIG. 1 (earlier case FIG. 1) is a front elevation view of a home beer dispensing apparatus in accordance with the present invention;

FIG. 2 (earlier case FIG. 2) is a side elevation view of the home beer dispensing apparatus;

FIG. 3 (earlier case FIG. 9) is a perspective view of the tap adapter showing the hollow arm thereof (through which the cartridge of the present invention extends), in an open positions;

FIG. 3a is an elevated sectional side view of the tap adapter mounted to a keg.

FIG. 4 is an exploded view of the presently contemplated best mode of the present invention depicting the relationship between the sleeve and the sections associated with a cartridge comprising a conduit for providing a venturi-type flow constriction therein.

FIG. 5 is a longitudinal section along the embodiment depicted in FIG. 4.

FIGS. 6 and 7 are respectively, exploded and longitudinal cross-sectional elevation views of an alternative beer dispense appliance cartridge embodiment according the present invention;

FIGS. 8 and 9 are corresponding views of yet another alternative embodiment of a beer dispense appliance cartridge according to the present invention; and,

FIG. 10 is a schematic representation of the structure and operation of a venturi-type flow restriction.

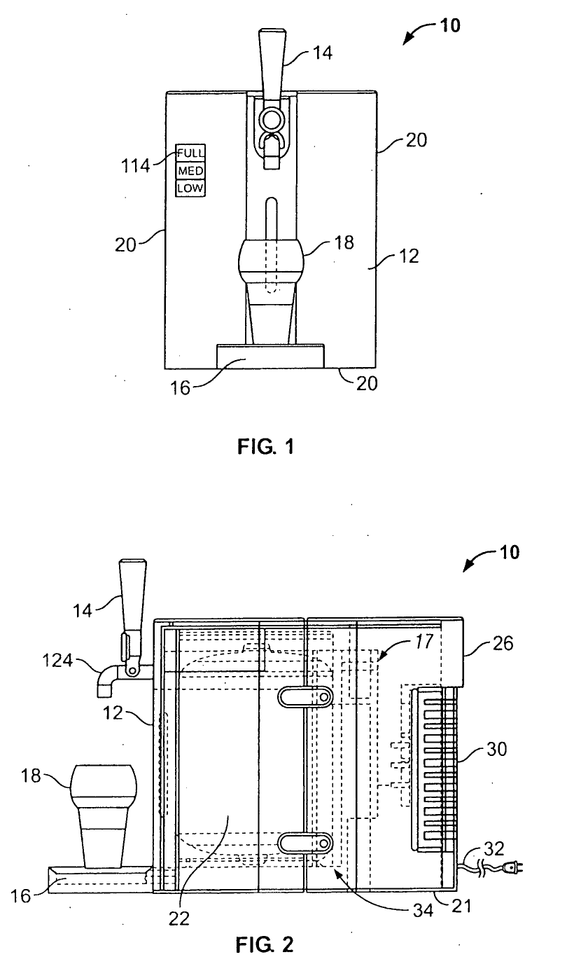

Referring now to FIGS. 1 and 2 in particular, there is shown a home beer dispensing apparatus, appliance or unit 10. The dispensing apparatus 10 is primarily intended for use in domestic kitchens but may also be used in utility rooms, garages, domestic bars, caravans etc. While the preferred embodiment relates to dispensing beer, alternatively carbonated solutions or other alcohol beverages may be dispensed by apparatus 10.

The home beer dispensing apparatus 10 has a front wall 12 and a dispensing tap 14 protruding forward of the front wall 12. A drip tray 16 also protrudes forward of the front wall 12 and is adapted to support an open glass container 18 below the dispensing tap 14. The home beer dispensing apparatus 10 further has a base 21 adapted to rest on a counter top. The front wall 12 is an extension of two pivoting side walls 20 which may be moved between closed and open positions to allow the keg 22 (see FIG. 2 in broken lines) to be inserted into the housing of the home beer dispensing apparatus 10.

The housing 17 of the home beer dispensing apparatus 10 further includes a top wall 24 and a rear wall 26. The rear wall 26 has a grill 30 that permits for air circulation within the home beer dispensing apparatus 10. An electrical cord 32 extends through the rear wall 26 of the apparatus 10 to provide a connection into a main electrical supply to supply electrical power to the electrical components housed within the unit 10. Alternatively, a 12 Volt DC supply input may be used.

The dispensing apparatus 10 has a cooling system 34 located behind and below keg 22 that is adapted to cool beer in keg 22 when keg 22 is placed into dispensing apparatus 10.

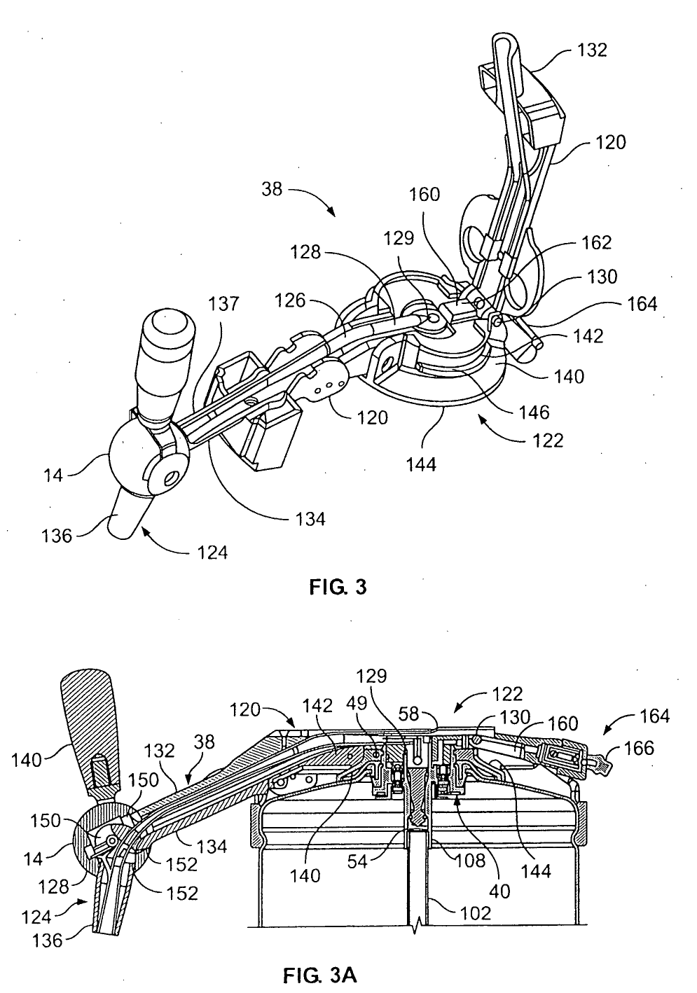

Referring now to FIG. 3, the tap adapter or keg interface, 38 useful in connection with the present invention is shown in more detail. The tap adapter 38 is mounted to the valve assembly 40 in fluid flow communication with the first valve 54. This attachment is a snap action sealed attachment on inner and outer walls of valve flange 49.

The dispenser adapter 38 has a hollow arm 120 that has a first end portion 122 adjacent the valve assembly 40 and a second end portion 124 which is remote therefrom. The first end portion 122 is connected to the first valve 54 so as to open the valve 54. This connection is made when the adapter is snap fitted downwardly onto the valve neck flange 49. The hollow arm 120 extends from the valve assembly 40 out through the housing 17 to a position where the remote end portion 124 of the hollow arm 120 is outside of the housing 17.

The hollow arm 120 is separable by a hinge point 130. The arm 120 is separable into an upper arm portion 132 and a lower arm portion 134. Lower arm portion 132 carries the tap 14 integral therewith. The lower arm portion 134 comprises a half hollowed out passageway 137.

The following describes in detail an embodiment wherein the foam controlling element takes the form of a cartridge located in the hollow arm 120 of the adaptor 38. Inserted into this lower arm portion 134 is a tubular cartridge 126 that has a tube 128 that interconnects the tap 14 with the first valve 54 so that the beverage may flow through the tube 128 and out the tap end 136. The cartridge 126 is in effect a frame like member which is adapted to be snap fitted into place with the lower arm portion 134. The cartridge 126 also carries the tube 128 there through for connection into the first end portion 122 of the hollow arm 120 so that when the cartridge is inserted into the hollow arm 120, and the hollow arm is subsequently mounted onto the valve assembly 40, one end 129 of the tube 128 sealingly engages passageway 48 and opens valve 54 so that beverage may be dispensed through valve 54 and into the tube 128. The upper arm portion 132 as shown in FIG. 9 may then be snapped back into place relative to the lower arm portion 132.

The adapter 38 is provided with a base portion 140 for supporting the hollow arm 120. The base portion 140 has a neck or supporting ring 142 that is adapted to surround and releasably engage the valve neck flange 49. The base portion 140 further includes an annular flange portion 144 which provides an inverse shape of a saucer that is adapted to abut the top surface of the keg 22 and to be supported thereon.

The base portion 140 has locking spring members 146 that engage the valve neck groove 47 and are movable to release the adapter 38 from the valve assembly 40.

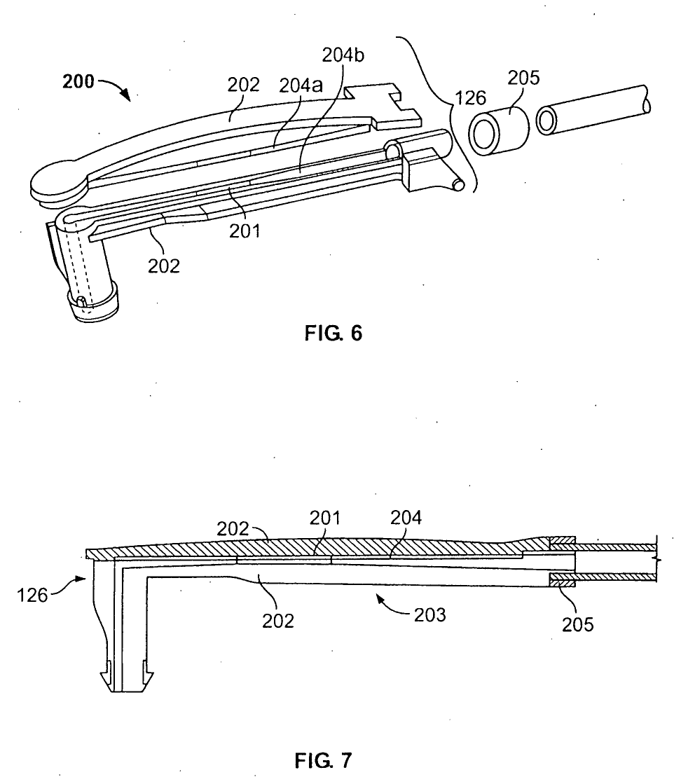

Tap 14 is connected to the remote end 124 of the hollow arm 120 and in particular the lower arm portion 134. The tap is operable between a closed position to shut off the flow of beverage through the hollow arm as shown in FIG. 6 and an open position permitting beverage to flow through the hollow arm and out the tap 14 as shown in FIG. 9. The tap 14 also forms an integral part of the hollow arm 120 and in particular the lower portion 134. The tap 14 has a handle 140 that is pivotally connected to a cam member 150 so as to rotate cam member 150 into pinching engagement against tube 128 as indicated at pinching point 152. The handle will be normally biased in this position and may be drawn forward to release cam member 150 from the tube 128 and thereby open the tube at point 152 and permit beverage to be dispensed along the tube 128 contained within the hollow arm 120 from the valve assembly 40.

The dispensing adapter 38 includes an air line passageway 160 adapted to be connected to a second air valve 58 in fluid flow communication. The air line passageway 160 has a first end or cap member 162 that connects to and opens the second valve 58 when the adapter 38 is snap fitted onto the valve system 40. The air line passageway 160 has a second end portion 164 having a one way air valve 166 that is normally shut and that is opened when connected to an air or other propellant fluid supply.

The adapter 38 of the present invention has many advantages. In particular, the adapter 38 can be sold as a separate part to a consumer and the cartridge 126 may be sold as a replacement cartridge with each keg 22 refill for insertion into adapter 38 so as to provide a sanitary dispensing medium for the beverage. The cartridge 126 is inserted into the adapter 38 and the adapter 38 is moved into its closed position and snapped onto the keg neck 47. Because the adapter carries the tap 14 which is in a closed position, the snapping of adapter 38 onto the valve assembly 40 of the keg 22 in sealing relation therewith opens valve 54 and provides for a simple and reliable connection that does not result in any loss of beverage. At this time, the air supply line 160 is connected to the air valve 58 of the valve assembly 40. The keg 22 is ready for use as a portable free standing unit.

The adapter 38 is now ready to dispense beverage by drawing handle 148 forward releasing the cam 150 from pinching the tube 128 allowing the beverage to flow there through out through valve 54.

Referring now to FIG. 10 of the drawings, there is illustrated a schematic longitudinal cross-section through a section of conduit 200 according to the present invention, in which the venturi 201 structure is illustrated. As dimensioned, and for the operating conditions set out, the arrangement is particularly suited to home beer dispense applications.

Referring to the drawings in general, and referring to an illustrative embodiment of the present invention, the beer line possesses a venturi or a portion of tube that: tapers down gradually from around 8 mm to 1.5 mm; continues at 1.5 mm diameter for 50 mm or 60 mm; and then expands outwards gradually back (through a back angle) to around 8 mm. The length and diameter of the restricted portion combine to determine both the delivered flow rate of beer and the pressure drop across the restrictor. In the preferred case, this should be around 1 bar—the internal pressure of the keg—to avoid beer foaming. The diameter of the restrictor is also an influential factor—too large a diameter and the dispense flow rate is too high and there is little pressure drop, too narrow a diameter and the dispense flow rate is very slow. In forming the venturi, the tapered convergent and divergent sections are adapted to ensure that vortices are not created in the beer flow, which would lead to out localized low pressure regions and related out-gassing and foaming.

In this example of a venturi system to reduce pressure and control flow, an 8 mm standard diameter tube is used, having a 1.5 mm diameter through the integrally formed venturi, which extends for a length of over 50 mm, and expands at a 20° inclusive angle (or by 10 degrees on both side) back to a final conduit diameter of 8 mm. This gradual return to the original tubing diameter reduces risk of foaming for the beer transiting this conduit (at about 2 litres/min.). Note that the same angles can be used on the upstream side of the venturi in reducing from the nominal tube diameter to the narrow venturi tube diameter. Under the conditions described herein and in the drawings, all sections of the conduit up stream of venturi including up to the keg valve, are above foaming pressure. Minimising distance after venturi to the dispense spout is also helpful.

Beer dispensing in this case involves a continuous dispense rate of between 1.5 liters/minute and 2.0 liters/minute without “excessive” foaming for the conditions described below. Air pressure maintained between 1.2 bar gauge and 1.5 bar gauge; beer temperature (bottom 25%) <9° C.

The cartridge is preferably a disposable item, and can be supplied new with each keg that a consumer purchases. Ease of use and sanitation are advantages of this arrangement.

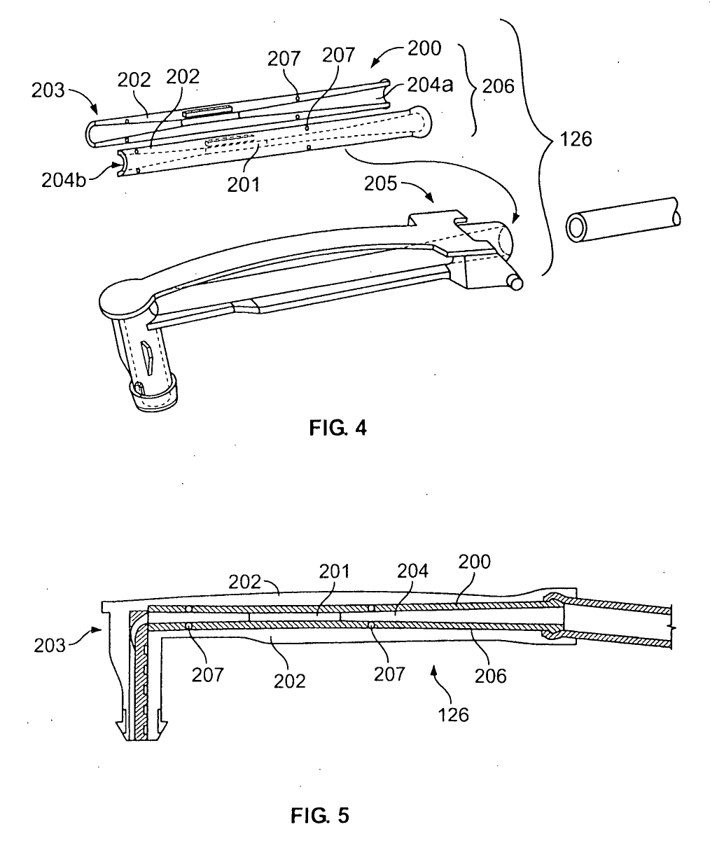

Referring to FIGS. 4 through 9 in general, there is illustrated a disposable cartridge 126 for use in a beer dispense appliance (not shown in these figures but refer, for example to FIGS. 1 and 2), that is adapted to engage in a beer keg connection interface (likewise, for example, as shown in FIG. 3), wherein the cartridge 126 includes means for interconnecting between said beer keg connection interface and a beer dispense tap, and further comprises a conduit 200 adapted to pass beer there-through and providing a flow restriction (exemplified by venturi construction 201), across an operational pressure drop between a beer inlet into and an outlet from said restriction:
wherein said conduit 200 comprises a cooperative plurality of longitudinal sections 202 of an elongated tubular body 203 enclosing a longitudinally-extending passage 204 for said fluid between respective mutually opposed surfaces 204a, 204b, thereof; and,
wherein said surfaces 204a and 204b, are conformed so that with said sections 202 arranged in conjoined relation, said flow restriction, (e.g. 201), is defined between said respective conformed surfaces 204a and 204b.

Referring now more particularly to FIGS. 4 and 5, the conduit 200 comprises clamping means 205 adapted to clampingly engage a cooperative plurality of mutually inter-fitting longitudinal sections 202 of an elongated tubular body 203 enclosing a longitudinally-extending passage 204 for said fluid between respective mutually opposed surfaces 204a and 204b thereof.

The flow restriction is again exemplified by a flow restricting venturi-type constriction 201 in said passage 204.

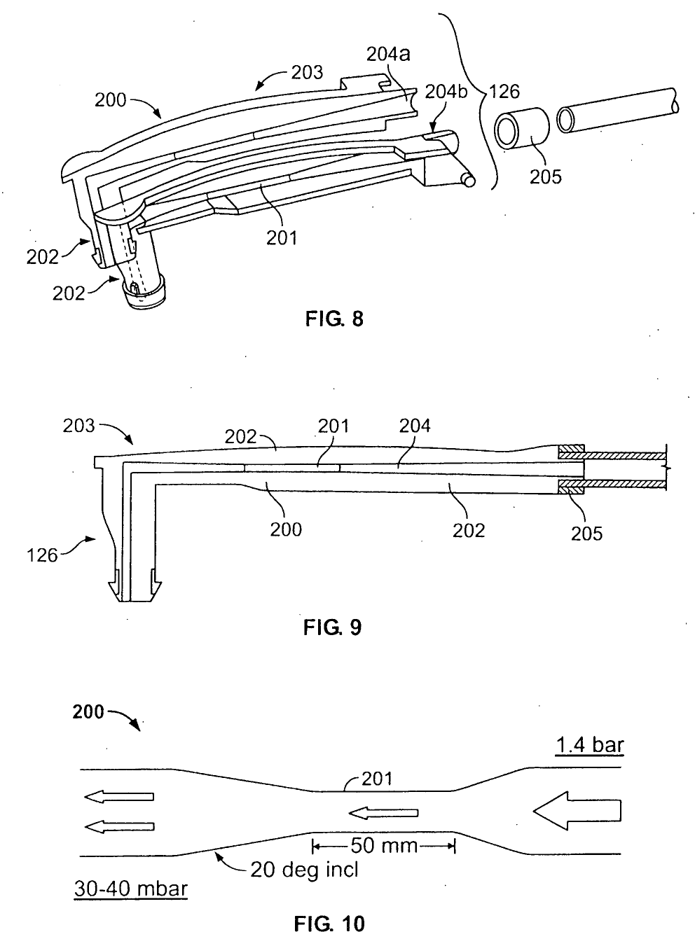

The particular clamping means associated with the embodiment shown in FIGS. 4 and 5 comprises a sleeve clamping means 205 formed within said conduit and said body 203 comprises an insert 206 comprising in turn an assembly of sections 202, that is then adapted to be received in clamped engagement within said sleeve clamping means 205. In the embodiment depicted in FIGS. 8 and 9 the clamping means comprises a clamping means 205 that functions both as a compression ring to secure a dispense tube to conduit 200. Also note however, that the compression ring 205 in the embodiment depicted in FIGS. 6 and 7, does not provide a clamping means function, but serves only as a compression ring in this particular case.

Note too that in the embodiments of FIGS. 6 to 9, the longitudinal sections 202, and tubular body 203 are all integral to portions of the conduit 200 of cartridge 126.

Also note that in FIGS. 4 and 5, corresponding cooperative surface features 207, provide for the mutual inter-fitting of sections 202.

Also note that in the best mode embodiment shown in FIGS. 4 and 5, the dimensions associated with the embodied venturi 201, differ from those illustrated in FIG. 10. Instead, beer enters assembly 206 between converging surfaces (13.9 degree angle of convergence) over a short longitudinal distance of about 5 mm, and then enters a constricted length of tube (a minimum of about 68 mm in length and about 1.9 mm in diameter). The beer flow then exits that region of venturi 201, between surface walls that diverge outwardly at an angle of about 3.9 degrees for about 40 mm to the end of body 203.

The present invention also relates to various method and assemblies related thereto. These includes a method of forming a venturi-type flow constriction comprising forming components thereof as various ones of a plurality of longitudinal sections adapted to be co-assembled as an elongated tubular body. Examples of such components include sections 202 of insert as shown in FIG. 4; or the tope and bottom sections 202 of conduit 206 as presented in FIG. 6, or the two side “half” sections 202 illustrated in FIG. 8. The venturi flow restrictions are formed on the exposed surfaces of these components prior to the assembly thereof around the passage that such surfaces come to define. This aspect of the invention extends therefore to the various individual venturi-type flow components as exemplified above.

The present invention also relates to a method for constructing a venturi-type flow restriction comprising forming a plurality of such parts or components for co-assembly, and then co-assembling same into an elongated tubular body as elaborated on elsewhere herein.

The formation of these diverse parts or components result in an incipient combination of venturi-type flow constriction components prior to their assembly, which also constitutes part of the present invention.

Lastly, the present invention comprises a method for assembling a venturi-type flow restriction comprising co-assembling a plurality of parts or components, as illustrated in respective pairs: FIGS. 4 and 5; FIGS. 6 and 7; and FIGS. 8 and 9—which depict the exploded and assemble views of the respective parts or components that are unique to their differing embodiments of the present invention.

1. A conduit, adapted to pass a fluid there-through and providing a flow restriction across an operational pressure drop between a fluid inlet into and an outlet from said restriction:
wherein said conduit comprises a cooperative plurality of longitudinal sections of an elongated tubular body enclosing a longitudinally-extending passage for said fluid between respective mutually opposed surfaces thereof, and,
wherein said surfaces are conformed so that with said sections arranged in conjoined relation, said flow restriction is defined between said respective conformed surfaces.

2. The conduit according to claim 1, wherein said sections are mutually inter-fitting sections and are adapted to be thereby engaged in cooperative inter-fitting register when arranged in said conjoined relation.

3. A conduit, adapted to pass a fluid there-through and providing a flow restriction across an operational pressure drop between a fluid inlet into and an outlet from said restriction:
wherein said conduit comprises clamping means adapted to clampingly engage a cooperative plurality of longitudinal sections of an elongated tubular body enclosing a longitudinally-extending passage for said fluid between respective mutually opposed surfaces thereof; and
wherein said surfaces are conformed so that with said sections arranged in clamped relation, said flow restriction is defined between said respective conformed surfaces.

4. The conduit according to claim 3 wherein said sections are mutually inter-fitting sections and are adapted to be thereby engaged in cooperative inter-fitting register when arranged in said conjoined relation.

5. The conduit according to claims 1, 2, 3 or 4 wherein said flow restriction is a flow restricting venturi-type constriction in said passage.

6. The conduit according to claims 1, 2, 3 or 4 wherein said clamping means comprises a sleeve and said body comprises an insert adapted to be received in clamped engagement within said sleeve.

7. A venturi-type flow constriction component comprising one of a plurality of longitudinal sections of an elongated tubular body, adapted to enclose a longitudinally-extending passage for a fluid between respective mutually opposed surfaces of said sections, wherein said surface is conformed so that with said plurality of sections arranged in conjoined relation a flow restriction is defined between said respective conformed surfaces.

8. The component according to claim 7 wherein said sections are mutually inter-fitting sections and are adapted to be thereby engaged in cooperative inter-fitting register when arranged in said conjoined relation.

9. A method of forming a venturi-type flow constriction comprising forming components thereof as various ones of a plurality of longitudinal sections adapted to be co-assembled as an elongated tubular body, and to enclose there between a longitudinally-extending passage for a fluid between respective mutually opposed surfaces of said sections, wherein said surfaces are conformed so that with said plurality of sections arranged in conjoined relation a flow restriction is defined between said respective conformed surfaces.

10. The method according to claim 9 wherein said sections are formed with mutually inter-fitting sections and are adapted to be thereby engaged in cooperative inter-fitting register when arranged in said conjoined relation.

11. A method for constructing a venturi-type flow restriction comprising forming a plurality of parts comprising various ones of a plurality of longitudinal sections and co-assembling same into an elongated tubular body, and to enclose between said sections a longitudinally-extending passage for a fluid between respective mutually opposed surfaces of said sections, wherein said surfaces are conformed so that with said plurality of sections arranged in conjoined relation, the venturi-type flow restriction is defined between said respective conformed surfaces.

12. The method according to claim 11 wherein said sections are mutually inter-fitting sections and are mutually engaged in cooperative inter-fitting register when said sections are arranged in said conjoined relation.

13. A method for assembling a venturi-type flow restriction comprising co-assembling a plurality of parts comprising various ones of a plurality of longitudinal sections, into an elongated tubular body, to enclose a longitudinally-extending passage for a fluid between respective mutually opposed surfaces of said sections, wherein said surfaces are conformed so that with said plurality of sections arranged in conjoined relation, the venturi-type flow restriction is defined between said respective conformed surfaces.

14. The method according to claim 13 wherein said sections are mutually inter-fitting sections and are engaged during assembly in cooperative inter-fitting register when said sections are arranged in said conjoined relation.

15. (canceled)

16. (canceled)

17. An incipient combination of venturi-type flow constriction components comprising various ones of a plurality of longitudinal sections of an elongated tubular body, collectively adapted to enclose a longitudinally-extending passage for a fluid between respective mutually opposed surfaces of said sections, wherein said surfaces are respectively conformed so that with said plurality of sections arranged in conjoined relation a flow restriction is defined between said respective conformed surfaces.

18. A conduit, adapted to pass “carbonated” liquid there-through and providing a flow restricting venturi for mitigating against foam production during transit of said liquid across an operational pressure drop between a liquid inlet into and an outlet from said venturi,
wherein said conduit comprises a clamping sleeve adapted to receive a cooperative plurality of longitudinal portions of an elongated tubular insert enclosing a longitudinally-extending passage for said liquid between respective mutually opposed surfaces thereof; and,
wherein said surfaces are conformed so that with said insert arranged in clamped relation within said sleeve, said venturi is defined between said respective conformed surfaces.

19. The conduit according to claim 18 wherein said sections are mutually inter-fitting sections and are adapted to be thereby engaged in cooperative inter-fitting register when arranged in said conjoined relation.

20. In a beverage dispense system, a conduit is adapted to pass a beverage there-through and provides a flow restriction across an operational pressure drop between a beverage inlet into and an outlet from said restriction:
wherein said conduit comprises a cooperative plurality of longitudinal sections of an elongated tubular body enclosing a longitudinally-extending passage for said fluid between respective mutually opposed surfaces thereof, and
wherein said surfaces are conformed so that with said sections arranged in conjoined relation, said flow restriction is defined between said respective conformed surfaces.

21. The beverage dispensing system according to claim 20 wherein said sections are mutually inter-fitting sections and are adapted to be thereby engaged in cooperative inter-fitting register when arranged in said conjoined relation.

22. In the beverage dispense system according to claims 20 or 21, wherein said conduit comprises clamping means adapted to clampingly engage a cooperative plurality of mutually inter-fitting longitudinal sections of an elongated tubular body enclosing a longitudinally-extending passage for said fluid between respective mutually opposed surfaces thereof, and, wherein said surfaces are conformed so that with said sections arranged in clamped relation and said portions engaged in cooperative inter-fitting register, said flow restriction is defined between said respective conformed surfaces.

23. In a beverage dispensing system according to claims 20 or 22, wherein said flow restriction is a flow restricting venturi-type constriction in said passage.

24. In a beverage dispensing system according to claims 20 or 22 wherein said clamping means comprises a sleeve and said body comprises an insert adapted to be received in clamped engagement within said sleeve.

25. A beverage dispensing system comprising in combination, means to receive a beverage-containing reservoir adapted to be connected in beverage dispensing relation to a beverage dispensing tap, and comprising a conduit arranged there between, said conduit being adapted to pass beer there-through and provide a flow restriction across an operational pressure drop between a beer inlet into and an outlet from said restriction:
wherein said conduit comprises a cooperative plurality of longitudinal sections of an elongated tubular body enclosing a longitudinally-extending passage for said fluid between respective mutually opposed surfaces thereof; and
wherein said surfaces are conformed so that with said sections arranged in conjoined relation, said flow restriction is defined between said respective conformed surfaces.

26. The beverage dispensing system according to claim 25 wherein said sections are mutually inter-fitting sections and are adapted to be thereby engaged in cooperative inter-fitting register when arranged in said conjoined relation.

27. The invention according to claim 25 or 26, wherein said conduit comprises clamping means adapted to clampingly engage a cooperative plurality of mutually inter-fitting longitudinal sections of an elongated tubular body enclosing a longitudinally-extending passage for said fluid between respective mutually opposed surfaces thereof.

28. The invention according to claim 27 wherein said flow restriction is a flow restricting venturi-type constriction in said passage.

29. The invention according to claim 28 herein said clamping means comprises a sleeve and said body comprises an insert adapted to be received in clamped engagement within said sleeve.

30. The beverage dispensing system according to claim 25 wherein said beverage is beer.

31. The beverage dispensing system according to claim 30 herein said system comprises a beer dispensing appliance.

32. The beer dispensing appliance according to claim 31 wherein said conduit comprises a disposable plastic cartridge.

33. The beer dispensing appliance according to claim 32 wherein said provision is made for only a short run between said reservoir and said tap.

34. A disposable cartridge for use in a beer dispense appliance, is adapted to engage in a beer keg connection interface, wherein the cartridge includes means for interconnecting between said beer keg connection interface and a beer dispense tap, and further comprises a conduit adapted to pass beer there-through and providing a flow restriction across an operational pressure drop between a beer inlet into and an outlet from said restriction:
wherein said conduit comprises a cooperative plurality of longitudinal sections of an elongated tubular body enclosing a longitudinally-extending passage for said fluid between respective mutually opposed surfaces thereof, and
wherein said surfaces are conformed so that with said sections arranged in conjoined relation, said flow restriction is defined between said respective conformed surfaces.

35. The conduit according to claim 34 wherein said sections are mutually inter-fitting sections and are adapted to be thereby engaged in cooperative inter-fitting register when arranged in said conjoined relation.

36. The invention according to claim 34 or 35 said conduit comprises clamping means adapted to clampingly engage a cooperative plurality of mutually inter-fitting longitudinal sections of an elongated tubular body enclosing a longitudinally-extending passage for said fluid between respective mutually opposed surfaces thereof.

37. The invention according to claim 36 wherein said flow restriction is a flow restricting venturi-type constriction in said passage.

38. The invention according to claim 37 wherein said clamping means comprises a sleeve and said body comprises an insert adapted to be received in clamped engagement within said sleeve.
